(19) United States
(12) Patent Application Publication
(10) Pub. No.: US 2016/0104323 A1
(43) Pub. Date: Apr. 14, 2016

(54) IMAGE DISPLAY DEVICE AND IMAGE DISPLAY METHOD

(71) Applicant: B-Core Inc., Tokyo (JP)

(72) Inventors: Yo TANAKA, Tokyo (JP); Tetsuya OKADA, Nagoya (JP)

(21) Appl. No.: 14/878,623

(22) Filed: Oct. 8, 2015

(30) Foreign Application Priority Data
Oct. 10, 2014 (JP) 2014-208822

(51) Int. Cl. G06T 19/00; G06T 15/00; G06T 19/20

(52) U.S. Cl. CPC G06T 19/006; G06T 19/20; G06T 15/00

(57) ABSTRACT

According to one embodiment, an image display device includes an acquisition module and a display processing module. The acquisition module is configured to acquire a taken image which is taken with a camera and which includes an optical recognition code representing identification information by forming a plurality of elements in a shape of a line. The display processing module is configured to superpose and display a three-dimensional object image corresponding to the identification information, on the taken image. An orientation of the three-dimensional object image superposed and displayed on the taken image is determined based on an orientation of the optical recognition code on the taken image and an inclination of the camera.

### CROSS-REFERENCE TO RELATED APPLICATIONS

This application is based upon and claims the benefit of priority from Japanese Patent Application No. 2014-208822, filed Oct. 10, 2014, the entire contents of which are incorporated herein by reference.

### FIELD

Embodiments described herein relate generally to an image display device and an image display method.

### BACKGROUND

Recently, technology called augmented reality (AR) (hereinafter, called AR technology) has become prominent.

In AR technology, for example, an image of a virtual object can be superposed on an image of real space taken by an image display device such as a camera-equipped smartphone.

A code (mark) of a predetermined shape called an AR marker is arranged on a real object in the real space by the AR technology. The image of the virtual object corresponding to the AR marker is displayed by taking an image of the AR marker with the image display device. The virtual object image includes, for example, a three-dimensional image.

Incidentally, the AR marker is often a mark (hereinafter called an AR mark) constituted by arranging, for example, a white region and a black region within a predetermined, substantially square range.

As regards the AR mark, orientation of the AR mark and a position (angle) of the image display device taking an image of the real space in which the AR marker is arranged can be detected by extracting, for example, points at four corners of the AR mark on the real space image, and the virtual object image can be displayed in accordance with the detected orientation and position.

To detect the orientation of the AR mark and the position of the image display device taking the image of the real space in which the AR marker is arranged, however, the AR mark of a certain size (area) (i.e., a mark in a substantially square shape) needs to be prepared. For this reason, when the AR mark is used, for example, a plurality of virtual object images is difficult to superpose on the real space image and display. In other words, the manner of use of the mark in a substantially square shape is limited, and flexibility of use is lowered.

### BRIEF DESCRIPTION OF THE DRAWINGS

FIG. 1 is an illustration showing an appearance of an image display device of an embodiment.

FIG. 2 is an illustration for explanation of a color bit code.

FIG. 3 is an illustration showing an example of hardware configuration of the image display device shown in FIG. 1.

FIG. 4 is a block diagram mainly showing a functional configuration of the image display device of the embodiment.

FIG. 5 is a flowchart showing processing steps of the image display device of the embodiment.

FIG. 6 is an illustration for explanation of a manner of displaying a display image.

FIG. 7 is an illustration for explanation of the manner of displaying the display image.

FIG. 8 is an illustration for explanation of the manner of displaying the display image.

FIG. 9 is an illustration for explanation of the manner of displaying the display image.

### DETAILED DESCRIPTION

Various embodiments will be described hereinafter with reference to the accompanying drawings.

In general, according to one embodiment, an image display device includes an acquisition module and a display processing module. The acquisition module is configured to acquire a taken image which is taken with a camera and which includes an optical recognition code representing identification information by forming a plurality of elements in a shape of a line. The display processing module is configured to superpose and display a three-dimensional object image corresponding to the identification information represented by the optical recognition code included in the acquired taken image, on the taken image. An orientation of the three-dimensional object image superposed and displayed on the taken image is determined based on an orientation of the optical recognition code on the taken image and an inclination of the camera.

FIG. 1 is an illustration showing an appearance of an image display device of the embodiment. The image display device of the embodiment is a camera-equipped information processing device and includes, for example, a smartphone, a tablet terminal, a personal computer (PC), etc. In FIG. 1, the image display device 10 is assumed to be a smartphone. A camera is installed in (built into), for example, a back surface of the image display device (smartphone) 10 shown in FIG. 1, though it is not shown.

By taking an image of an optical recognition code (optical symbol) by the camera, the image display device 10 of the embodiment can read the optical recognition code. The optical recognition code which can be read by the image display device 10 of the embodiment is, for example, a code obtained by forming a plurality of elements in a shape of a line (rod). More specifically, the optical recognition code includes, for example, a code (hereinafter called a color bit code) formed by aligning a plurality of cells (elements) each having one of at least three colors. According to the color bit code, identification information (for example, ID) can be represented by transition of the color on each of aligned cells.

In the following explanations, the optical recognition code which is read by the image display device 10 of the embodiment is assumed to be a color bit code.

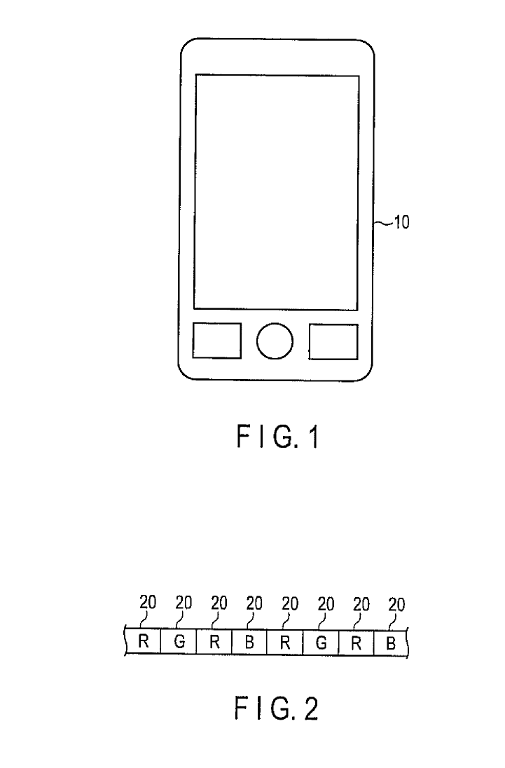

The color bit code is explained with reference to FIG. 2. A part of the color bit code is illustrated in FIG. 2 for convenience.

As shown in FIG. 2, the color bit code is constituted by, for example, aligning a plurality of cells 20 each having one of colors such as red, green and blue. In FIG. 2, red is represented by R, green is represented by G and blue is represented by B. FIG. 2 shows an example of using three colors (red, green and blue) for the color bit code for convenience of explanations, but at least four colors may be used for the color bit code if transition of the color on each cell can be identified.

The cell 20 constituting the color bit code is a range or a region to which one color is applied, and can be formed in various shapes. Each of a plurality of cells 20 is in the form of a square in the example of FIG. 2, but may be in the form of, for example, a circle or a triangle. The color bit code can be formed by arranging a plurality of cells 20 in the form of a line. The line may be a straight line or a curve.

The number of the cells 20 constituting the color bit code is predetermined. In addition, since the color bit code represents specific data by the color transition as explained above, not the same color, but different colors are applied to adjacent cells 20. The color bit code is made under these conditions.

In addition, endpoint cells are included in a plurality of cells 20 constituting the color bit code. The endpoint cells are located at endpoints of the color bit code formed of a group of linearly joined cells. The cell in the code is adjacent to two cells, but the endpoint cell is adjacent to only one cell. The code definitely includes two endpoint cells. Two endpoints are definitely different in color. It can be determined which endpoint cell is a start point by its color.

According to the color bit code, for example, since specific identification information can be represented by transition (arrangement) of three colors, limitation of the size and shape of the region of each color in the color bit code is loose, and high reading accuracy can be obtained even if the color bit code is applied onto, for example, a bumpy surface or a flexible material.

In the embodiment, the color bit code is used for the technology called augmented reality (AR) (AR technology), as an AR marker. In other words, the image display device 10 has a function of, when an image of the color bit code arranged as the AR marker on a real object in the real space is taken by the camera, displaying an image (video) of a virtual object (three-dimensional object) corresponding to the identification information represented by the color bit code included in the image taken by the camera (hereinafter called a taken image), on the taken image.

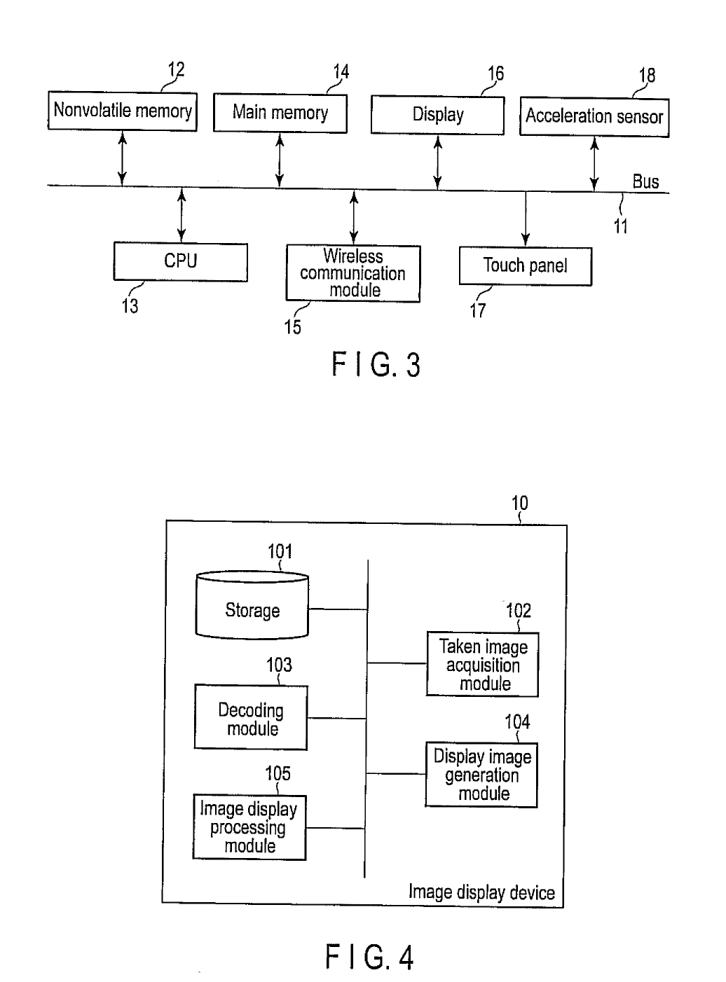

FIG. 3 shows an example of hardware configuration of the image display device 10 shown in FIG. 1. As explained above, the image display device 10 is assumed to be a smartphone.

As shown in FIG. 3, a nonvolatile memory 12, a CPU 13, a main memory 14, a wireless communication module 15, a display 16, a touch panel 17, an acceleration sensor 18, etc., are connected to a bus 11, in the image display device 10. The camera is not shown in FIG. 3.

The nonvolatile memory 12 stores, for example, various programs including the operating system (OS) and programs for implementing processing of reading the color bit code and processing relating to the AR technology.

The CPU 13 executes, for example, various programs stored in the nonvolatile memory 12. The CPU 13 controls the entire body of the image display device 10.

The main memory 14 is used as, for example, a work area which is considered necessary when the CPU 13 executes various programs, etc.

The wireless communication module 15 has a function of controlling communications with external devices such as various server devices via a network such as the Internet. In addition, the wireless communication module 15 has, for example, a wireless communication function such as wireless LAN, Bluetooth (registered trademark) or Wifi (registered trademark).

The display 16 has a function of displaying various data, etc., by including, for example, a liquid crystal display panel and a driving circuit which executes the display control. The image taken by the camera installed in the image display device 10 can be displayed on the display 16.

The touch panel 17 is arranged to be superposed on the front surface of the display 16, and has a function of detecting a position on the screen designated by, for example, a user's finger. The touch panel 17 can thereby detect various user operations on the image display device 10.

The acceleration sensor 18 is a sensor configured to detect the acceleration (for example, gravitational acceleration) acting on the image display device 10. The acceleration sensor 18 is, for example, a triaxial acceleration sensor (three-dimensional acceleration sensor) capable of detecting the acceleration of three orthogonal axes (x-axis, y-axis and z-axis) in the respective axial directions. By using the acceleration sensor 18 in the image display device 10, inclination of (the camera installed in) the image display device 10 can be detected. The acceleration sensor 18 is used in the embodiment, but any other sensor (for example, a gyro sensor, etc.) capable of detecting the inclination of the image display device 10 may be used.

FIG. 4 is a block diagram mainly showing a functional configuration of the image display device 10 of the embodiment. As shown in FIG. 4, the image display device 10 includes storage 101, a taken image acquisition module 102, a decoding module 103, a display image generation module 104 and an image display processing module 105.

In the present embodiment, the storage 101 is stored in, for example, the nonvolatile memory 12 shown in FIG. 3, etc. In addition, the taken image acquisition module 102, the decoding module 103, the display image generation module 104 and the image display processing module 105 are implemented by causing the CPU 13 shown in FIG. 3 (i.e., the computer of the image display device 10) to execute the program stored in the nonvolatile memory 12. The program can be prestored in a computer-readable storage medium and distributed. The program may be, for example, downloaded in the image display device 10 via a network.

The storage 101 prestores an image of the three-dimensional object corresponding to the identification information (hereinafter called a three-dimensional object image), in association with the identification information represented by the color bit code.

The taken image acquisition module 102 acquires a taken image (data) obtained by allowing the camera installed in the image display device 10 to take an image of the color bit code arranged on the real object. In other words, the taken image acquired by the taken image acquisition module 102 includes the color bit code and is constituted by a plurality of pixels, i.e., minimum units of color information. Acquaintance of the taken image which is taken by the camera installed in the image display device 10 has been explained, but the taken image acquisition module 102 may acquire, for example, a taken image which is taken by a camera outside the image display device 10.

The decoding module 103 executes processing of reading (decoding) the color bit code included in the taken image acquired by the taken image acquisition module 102. The decoding at the decoding module 103 is executed based on the transition of the colors in the color bit code (i.e., the transition of the colors on the respective cells 20 constituting the color bit code). The decoding module 103 thereby acquires the identification information represented by the color bit code included in the taken image.

The display image generation module 104 acquires the three-dimensional object image stored in the storage 101 in association with the identification information acquired by the decoding module 103. In addition, the display image generation module 104 calculates orientation of the color bit code on the taken image acquired by the taken image acquisition module 102. Furthermore, the display image generation module 104 calculates a relative position of (the camera installed in) the image display device 10 to the color bit code, based on the inclination of the image display device 10 detected by using the acceleration sensor 18.

The display image generation module 104 generates the display image having the orientation of the acquired three-dimensional object image changed based on the calculated orientation of the color bit code on the taken image and the calculated relative position of the image display device 10. In other words, the orientation of the three-dimensional object image on the display image is determined based on the orientation of the color bit code on the taken image and the inclination of (the camera installed in) the image display device 10.

The image display processing module 105 displays the display image (three-dimensional object image) generated by the display image generation module 104, on the color bit included in the taken image.

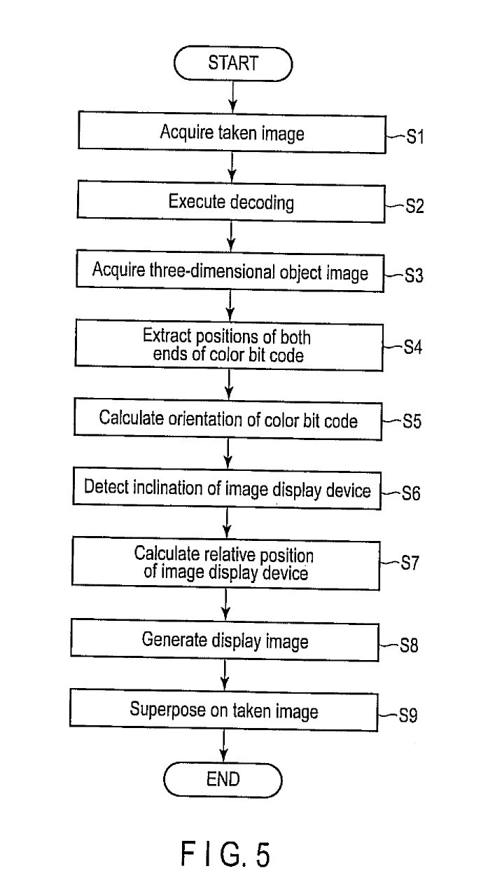

Next, processing steps of the image display device 10 of the embodiment will be explained with reference to a flowchart of FIG. 5.

First, the user using the image display device 10 activates the camera installed in the image display device 10 by operating the image display device 10. In this case, the user adjusts a camera position such that the color bit code arranged (or applied) on the real object is included in the angle of view of the camera, and thereby the camera can take an image of the color bit code. In the embodiment, the color bit code (AR marker) is assumed to be arranged on an approximately horizontal plane.

When the image of the color bit code is taken by the camera, the image acquisition module 102 acquires the taken image including the color bit code (step S1).

Next, the decoding module 103 executes decoding (reading) the color bit code included in the taken image acquired in step S1 (step S2). The decoding in step S2 will be hereinafter explained more specifically.

First, the decoding module 103 executes processing of dividing the taken image into the color regions (hereinafter called color region dividing processing). In general, the taken image and the background are constituted by various colors, and their patterns are also various. For this reason, processing (color averaging processing) of dividing the colors in the taken image into red, green, blue and achromatic color in the color space and assigning the color of each pixel to any one of the regions is executed in the color region dividing processing. In other words, labeling each pixel in the taken image is executed in the color region dividing processing.

The red, green and blue colors are defined as the colors applied to the respective cells constituting the color bit code (hereinafter called constituent colors) but, for example, when a color is implied within a certain range in which it can be recognized as the constituent colors in the color space in consideration of illumination, coloring, fading, etc., (a pixel of) the color is classified as the constituent color, in the color region dividing processing. In other words, when, for example, the red region is divided, all the color pixels within a certain range around the red color are recognized as red regions. The achromatic color is a color other than colors recognized as red, green and blue in the color region dividing processing.

The taken image is subjected to the color averaging processing as explained above but, in general, the taken image often includes a noise component. In the case of color variation at a fine site corresponding to the noise, the noise should preferably be eliminated by noise elimination such as causing the color to match the ambient color or averaging the color.

Next, the decoding module 103 executes processing (hereinafter called code cutting processing) of cutting the color bit code region (hereinafter called a code region) formed by arranging the regions of a plurality of constituent colors (red, green and blue), based on the color regions divided by the color region dividing processing. In the code cutting processing, the code region is cut based on the colors around each color region (for example, arrangement of the other constituent color regions and the achromatic color region, etc.), the number of cells constituting the color bit code, etc.

The color region dividing processing and the code cutting processing are not explained in detail here since they are disclosed in, for example, JP 200B-287414A.

Next, the decoding module 103 executes processing of verifying validity of the color bit code included in the taken image. More specifically, when the number of the color regions arranged in the code region cut from the taken image by the code cutting processing matches the predetermined number of the cells 20 arranged in the color bit code, the decoding module 103 determines that the color bit code included in the taken image is valid. In contrast, when the number of the color regions arranged in the code region cut from the taken image by the code cutting processing does not match the predetermined number of the cells 20 constituting the color bit code, the decoding module 103 determines that the color bit code included in the taken image is invalid.

The use of the predetermined number of cells 20 for verification of the validity of the color bit code has been explained, but a rule of arrangement of valid colors (cells) in the color bit code, etc., may be applied to the verification. In other words, the color bit code included in the taken image may be determined to be valid when the order (arrangement) of the color regions (colors) arranged in the code region cut from the taken image is applied to the rule, and the color bit code may be determined to be invalid when the order (arrangement) of the color regions (colors) is not applied to the rule.

The processing of verifying the validity of the color bit code is one of examples and the validity of the color bit code may be verified by the other processing. More specifically, the validity (matching) may be verified by check digit, etc.

When the color bit code is determined to be valid, the decoding module 103 decodes the color bit code, based on the transition of the colors in the color regions (i.e., the order of the color regions) arranged in the code region cut from the taken image by the code cutting processing. According to this, identification information represented by, for example, the transition of colors from the start cell 20 to the end cell 20 in the color bit code is acquired. In contrast, when the color bit code is determined to be invalid, for example, the user is notified that the color bit code cannot be decoded, and the processing is ended.

When the decoding is executed by the decoding module 103 as explained above, the display image generation module 104 acquires the three-dimensional object image in association with the identification information acquired by the decoding module 103 (i.e., the three-dimensional object image corresponding to the identification information) (step S3).

Next, the display image generation module 104 extracts the positions of (endpoint cells 20 located at) both ends of the color bit code included in the taken image, on the taken image acquired by the taken image acquisition module 102 (step S4).

Furthermore, (the colors assigned to) the endpoint cells can be identified as explained above, and it can be determined whether the endpoint cell is the start cell or the end cell. The display image generation module 104 thereby extracts two cells 20 (start cell 20 and end cell 20) corresponding to both ends of the color bit code, from a plurality of color regions (i.e., a plurality of cells 20) arranged in the code region cut from the taken image. In this case, the display image generation module 104 acquires positions (coordinates) of the extracted start cell 20 and end cell 20.

The display image generation module 104 calculates the orientation of the color bit code on the taken image, based on the positions of the extracted ends of the color bit code (i.e., the positions of the start cell 20 and the end cell 20) (step S5). Information of the shape (and the size) of the color bit code arranged on the real object (i.e., taken by the camera) is preliminarily stored in the image display device 10. The display image generation module 104 thereby becomes capable of calculating the orientation of the color bit code from the position of the start cell 20 and the position of the end cell 20.

Besides the information of the shape and the size of the color bit code, information on the angle of view of the camera installed in the image display device 10 (i.e., the range of taking an image by the camera), etc., are also stored in the image display device 10.

As regards the mark (hereinafter called AR mark) constituted by arranging, for example, a white region and a black region within a predetermined, substantially square range generally used as the AR marker, the position (angle) of the image display device 10 relative to the mark can be detected by extracting, for example, (positions of) four corner points of the AR mark. The orientation of the three-dimensional object image can be changed in response to the AR mark and the positional relationship of the image display device 10.

In contrast, the positions of both ends (start cell 20 and end cell 20) of the color bit code alone can be extracted from the color bit code used as the AR marker in the embodiment, as explained above. In this case, the orientation of the color bit code on the taken image can be calculated from the taken image as explained above, but the position (relative position) of the image display device 10 relative to the color bit code cannot be calculated.

Thus, the image display device 10 of the embodiment uses the acceleration sensor 18 installed in the image display device 10, to calculate the position of the image display device 10 relative to the color bit code taken by the camera.

In this case, the display image generation module 104 acquires the acceleration detected by the acceleration sensor 18 (i.e., the gravitational acceleration acting on the image display device 10). The display image generation module 104 thereby detects (calculates) the inclination of (the camera installed in) the image display device 10, based on the acquired gravitational acceleration (step S6).

The display image generation module 104 calculates the relative position of (the camera installed in) the image display device 10 to the color bit code, based on the positions of both ends of the color bit code extracted in step S4 (i.e., the position of the color bit code on the taken image), the inclination of the image display device 10 detected in step S6, and the information preliminarily stored in the image display device 10 (i.e., the information on the shape and size of the color bit code, the information on the angle of view of the camera installed in the image display device 10) (step S7).

The display image generation module 104 generates the display image obtained by changing the orientation of the three-dimensional object image acquired in step S3, based on the orientation of the color bit code on the taken image as calculated in step S5 and the relative position of the image display device 10 to the color bit code as calculated in step S7 (step S8). In this case, the display image generated by the display image generation module 104 is, for example, an image obtained by seeing the three-dimensional object facing in the direction of the color bit code from the relative position of the image display device 10 to the color bit code. The size of the three-dimensional object (image) may be determined based on the relative position of the image display device 10 to the color bit code. More specifically, a smaller three-dimensional object (image) can be displayed when a distance from the color bit code to the image display device 10 is long, and a larger three-dimensional object (image) can be displayed when the distance from the color bit code to the image display device 10 is short.

In other words, the display image generated by the display image generation module 104 (i.e., the orientation of the three-dimensional object image) is changed in accordance with the positional relationship between the color bit code and the image display device 10.

The image display processing module 105 superposes and displays the display image generated in step S8 on the taken image acquired in step S1 (step S9). More specifically, the display image is displayed on the color bit code included in the taken image. The display image may be displayed on a position other than the color bit code included in the taken image (for example, near the color bit code).

According to the processing shown in FIG. 5, as explained above, for example, even if the color bit code formed in a shape of a line is used as the AR marker, the three-dimensional object image having the orientation changed in accordance with the positional relationship between the color bit code and the image display device 10 can be displayed on (the color bit code included in) the taken image.

The processing shown in FIG. 5 is executed every time the image of (the real space including) the color bit code is taken by the camera (i.e., every time the taken image is acquired).

In addition, it has been mainly explained that one color bit code (i.e., one code region cut from the taken image) is included in the taken image but, if a plurality of color bit codes are included in the taken image, the processing in steps S2 to S9 may be executed for each of the color bit codes.

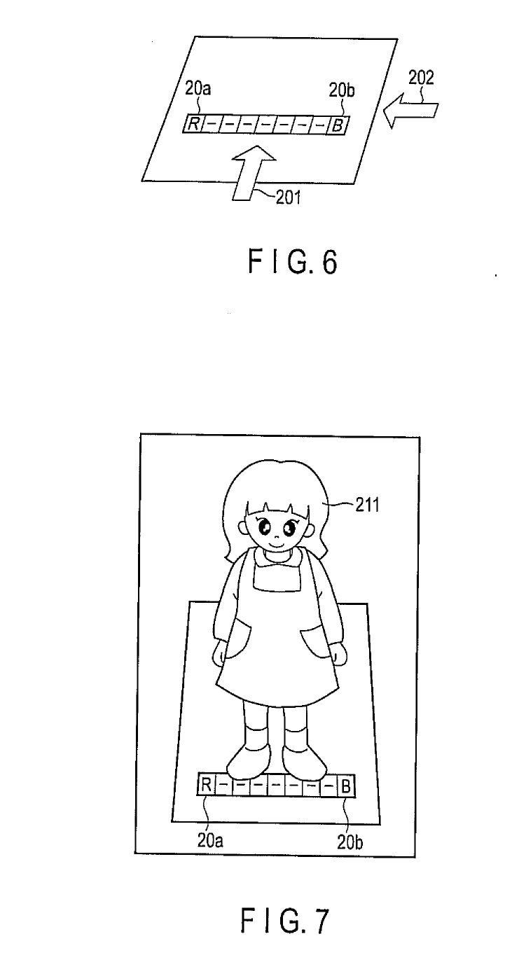

A manner of display of the display image will be explained hereinafter with reference to FIG. 6 to FIG. 9. FIG. 6 is an illustration showing the real space in which the color bit code is arranged. In the explanations of FIG. 6 to FIG. 9, two cells 20 at both ends of the color bit code are regarded as the start cell 20a and the end cell 20b.

When the color bit code formed in a shape of a line is arranged on the real object and an image of the color bit code is taken by a camera (not shown) from a direction of arrow 201 as shown in FIG. 6, a three-dimensional object image 211 of a predetermined character (for example, girl) is displayed on the color bit code as shown in FIG. 7. More specifically, the example shown in FIG. 7 represents, for example, the color bit code and the three-dimensional object image 211 wherein the start cell 20a of the color bit code is at the right and the end cell 20b of the color bit code is at the left of the three-dimensional object (i.e., the image of the front surface of the character seen from a slightly upper side).

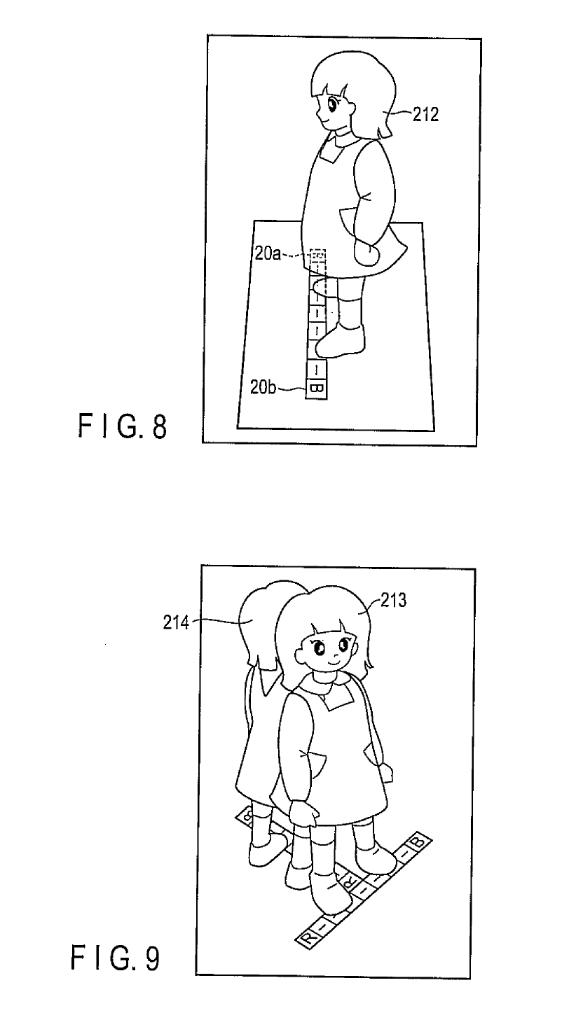

In contrast, when the color bit code is arranged on the real object and an image of the color bit code is taken by the camera from a direction of arrow 202 as 30, shown in FIG. 6, a three-dimensional object image 212 of the predetermined character is displayed on the color bit code as shown in FIG. 8. More specifically, the example shown in FIG. 8 represents, for example, the color bit code and the three-dimensional object image 211 wherein the start cell 20a of the color bit code is at the right and the end cell 20b of the color bit code is at the left of the three-dimensional object, similarly to FIG. 7 (i.e., the image of the left side of the character seen from a slightly upper side).

For example, when a plurality of color bit codes are arranged in close vicinity of each other and when an image including the color bit codes is taken by the camera, three-dimensional object images 213 and 214 are displayed so as to be superposed on the respective color bit codes as shown in FIG. 9.

In the embodiment, as explained above, the taken image including the color bit code (optical recognition code) taken by the camera is acquired, and the three-dimensional object image corresponding to the identification information represented by the color bit code included in the acquired taken image is superposed on the taken image (for example, the color bit code). The orientation of the three-dimensional object image superposed on the display image is determined based on the orientation of the color bit code on the taken image and the inclination of the camera.

More specifically, the orientation of the color bit code is calculated based on the positions of the start cell 20 and the end cell 20 located on both ends of the color bit code on the taken image, the relative position of the camera to the color bit code is calculated based on the inclination of the camera detected by using the acceleration sensor 18, and the display image having the orientation of the three-dimensional object image changed based on the orientation of the color bit code and the relative position of the camera is generated.

In other words, in the embodiment, the three-dimensional object (images) can be displayed at various angles, in accordance with the positions (angles) of the camera.

In the embodiment, in such a configuration, the color bit code having more flexibility as compared with the AR mark, etc., constituted by arranging the white region and the black region within a predetermined range in an approximately square shape generally used as the AR marker can be used as the AR marker.

For example, when the AR mark is used, the AR mark in a certain size needs to be prepared. In contrast, when the color bit code is used, limitation of the size and shape of the region occupied by the color bit code is loose. For this reason, a plurality of three-dimensional object (images) can be displayed to be superposed by arranging a plurality of color bit codes formed by linearly arranging a plurality of cells 20 as shown in, for example, FIG. 9, in the embodiment.

Since reading the color bit code can be implemented at a high accuracy, the color bit code can often be read at, for example, a position where the AR mark cannot be read. In addition, the color bit code is readable in a wider range than the AR mark. In addition, in the embodiment, the three-dimensional object image can be displayed when the color bit code alone can be read. According to the embodiment, the AR (technology) can be therefore used within a wider range as compared with use of the AR mark.

In other words, according to the embodiment, even if the AR technology is used, the characteristics of the color bit code which is more beneficial as compared with the general AR mark can be utilized (i.e., the benefits of the color bit code can be obtained), since the color bit can be used as the AR marker by using the acceleration sensor 18 installed in the image display device 10 such as a smartphone.

Various manners of using the image display device 10 of the embodiment are conceivable. A card game has been recently spread worldwide, and the image display device 10 of the embodiment can be used by applying the color bit codes on (ends, etc., of) cards used in the card game. In this case, by taking an image of (the color bit codes on) the card by the camera installed in the image display device 10, for example, a three-dimensional image (video) of a character corresponding to the card can be superposed and displayed on, for example, the taken image. When the image display device 10 of the embodiment is used in the card game in this manner, entertainment of the card game can be enhanced dramatically.

Furthermore, when a large color bit code is used as the AR marker, the image display device 10 can be used while the color bit code is arranged, for example, the color bit code (on a floor) beside a person. In this case, by taking an image such that both the person and the color bit code are included in the angle of view of the camera, for example, a three-dimensional image of a life-size character can be displayed on the taken image. A person placing its arm around a shoulder of the life-size character or shaking hands with the life-size character in the taken image can be displayed on the image display device 10, and the image can be stored as needed. When a plurality of color bit codes are arranged in a room, etc., and the image display device 10 is used, an image of the room can be taken by the camera installed in the image display device 10 and an image showing desired furniture, etc., arranged (displayed) on the taken image (i.e., the image of the room) can be obtained.

In addition, the image display device 10 can be used while a color bit code is applied to, for example, a corner of a display board near an exhibit in a museum. In this case, by taking an image of (the color bit code on) the display board by the camera installed in the image display device 10, for example, a three-dimensional image (video) for explanation relating to the exhibit can be displayed.

In addition, the image display device 10 can be used while a color bit code is printed at, for example, a corner of a signboard (or a poster) in a town. In this case, by taking an image of (the color bit codes on) the signboard by the camera installed in the image display device 10, for example, the position of the signboard (i.e., the position of the user using the image display device 10) and information on the surrounding of the signboard can be displayed as a three-dimensional image. Unlike a bar code and QR code (registered trademark), the color bit code has a significant benefit that the user does not need to move closely to the color bit code for reading.

In addition, for example, a signboard using three color LEDs (hereinafter called an LED signboard) has been widespread. As to the LED signboard, the image display device 10 can be used while a color bit code using three colors on the LED signboard as constituent colors is designed and displayed on a part of the LED signboard. In this case, by taking an image of the color bit code on a part of the LED signboard by the camera installed in the image display device 10, various types of information can be displayed as a three-dimensional image, on the image display device 10 (i.e., on the taken image). Furthermore, different images can also be displayed by changing, for example, the angle.

In the embodiment, the three-dimensional object image corresponding to (the identification information represented by) the color bit code taken (read) by the camera installed in the image display device 10 is stored in the image display device 10 (storage module 101), but the three-dimensional object image may be stored in a server device, etc., outside the image display device 10. In this case, the image display device 10 may transmit to the server device the identification information acquired by reading the color bit code and acquire the three-dimensional object image corresponding to the identification information from the server device.

In addition, use of the color bit code as the AR marker has been explained in the embodiment, but the embodiment can use, for example, other codes such as a bar code, a two-dimensional code and a grid-type color code if positions of both ends (i.e., two points) of the code can be extracted. Furthermore, the embodiment can display the three-dimensional image by using the display of not only the code obtained by forming a plurality of elements in a shape of a line (rod) such as the color bit code, but also two arbitrary points.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display device, comprising:
an acquisition module configured to acquire a taken image which is taken with a camera and which includes an optical recognition code representing identification information by forming a plurality of elements in a shape of a line; and
a display processing module configured to superpose and display a three-dimensional object image corresponding to the identification information represented by the optical recognition code included in the acquired taken image, on the taken image,
an orientation of the three-dimensional object image superposed and displayed on the taken image being determined based on an orientation of the optical recognition code on the taken image and an inclination of the camera.

2. An image display device, comprising:
a first acquisition module configured to acquire a taken image which is taken with a camera and which includes an optical recognition code representing identification information by forming a plurality of elements in a shape of a line;
a second acquisition module configured to acquire the identification information represented by the optical recognition code by reading the optical recognition code included in the taken image;
a third acquisition module configured to acquire a three-dimensional object image corresponding to the identification information;
an extraction module configured to extract positions of elements located at both ends of the optical recognition code formed in the shape of the line on the taken image;
a first calculation module configured to calculate an orientation of the optical recognition code on the taken image, based on the extracted positions of the elements located at the both ends of the optical recognition code;
a detection module which detects an inclination of the camera;
a second calculation module configured to calculate a relative position of the camera to the optical recognition code, based on the detected inclination of the camera;
a generation module configured to generate a display image obtained by changing an orientation of the acquired three-dimensional object image, based on the orientation of the optical recognition code on the taken image and the relative position of the camera; and
a display processing module configured to superpose and display the generated display image on the taken image.

3. The image display device of claim 2, wherein
the optical recognition code includes a code obtained by arranging a plurality of cells, and one of at least three colors is applied to each of the cells.

4. The image display device of claim 3, wherein
the display processing module is configured to display the generated display image on the optical recognition code included in the taken image.

5. A method of displaying an image comprising:
acquiring a taken image which is taken with a camera and which includes an optical recognition code representing identification information by forming a plurality of elements in a shape of a line; and
superposing and displaying a three-dimensional object image corresponding to the identification information represented by the optical recognition code included in the acquired taken image, on the taken image,
an orientation of the three-dimensional object image superposed and displayed on the taken image being determined based on an orientation of the optical recognition code on the taken image and an inclination of the camera.
